(19) United States
(12) Patent Application Publication
(10) Pub. No.: US 2013/0061303 A1
(43) Pub. Date: Mar. 7, 2013

(54) Authentication System and Method in a Contactless Environment

(71) Applicants: Jason Dean Hart, Fremont, CA (US); Matthew Patrick Herscovitch, Chapman (AU); Sotoudeh Hamedi-Hagh, Fremont, CA (US); Sooseok Oh, Fremont, CA (US)

(72) Inventors: Jason Dean Hart, Fremont, CA (US); Matthew Patrick Herscovitch, Chapman (AU); Sotoudeh Hamedi-Hagh, Fremont, CA (US); Sooseok Oh, Fremont, CA (US)

(73) Assignee: IDONDEMAND, INC., Fremont, CA (US)

(21) Appl. No.: 13/579,233

(22) PCT Filed: Feb. 25, 2011
(86) PCT No.: PCT/AU11/00207

§ 371 Date: Nov. 21, 2012

Related U.S. Application Data
(60) Provisional application No. 61/308,164, filed on Feb. 25, 2010.
(60) Provisional application No. 61/373,739, filed on Aug. 13, 2010.

(30) Foreign Application Priority Data
Oct. 13, 2010 (AU) 2010230088

(51) Int. Cl. G06F 21/00

(52) U.S. Cl. 726/6

(57) ABSTRACT

A method of providing continuous authentication in a contactless environment is provided. The method includes providing a reader having a contactless interface, as well as a device, operable to communicate with the reader. The method further includes the steps of receiving at the reader a first authentication request from the device, and communicating from the reader a second authentication request to a secure transaction service. The secure transaction service holds authentication credentials relating to the device. Authentication credentials relating to the device are received at the reader from the secure transaction service, and the reader provides continuous authentication based at least in part on the authentication credentials received from the secure transaction service.

### FIELD OF THE INVENTION

The present invention relates to computer security. More particularly, it concerns a system and method for providing user authentication in a contactless environment.

### DESCRIPTION OF THE RELATED ART

Smartcards are an extremely reliable model for implementing various security functions using Public Key Infrastructure (PKI). Generally, smartcards are docked or continuously connected in some manner to a smartcard reader allowing secure user authentication and transactions involving encryption, electronic certificates or electronic signatures.

A contactless smartcard includes a particular chip embedded in the card that is able to communicate with a card reader using RFID electromagnetic induction technology.

Contactless smartcard communication complies with a number of industry standards, including the ISO/IEC 14443 standard, operating at the 13.56 MHz frequency, allowing for communication distances of up to 10 centimeters between the smartcard and the corresponding reader. Such a distance proves suitable for transactions that require processing relatively quickly, and as such, contactless smartcards are commonly used for fare collection on transit systems, building access or for controlled financial transactions.

Traditionally, contactless smartcards have not been used for continuous authentication using PKI, as the smartcard must remain in the readers field for extended periods of time. This is generally impractical for most users, as smartcards must be worn on the user to confirm identification or are stored in a relatively secure location, such as a user's wallet or purse; generally beyond the 10 centimeter range of the reader.

Further, a host operating system using PKI for encryption/decryption and electronic signatures requires constant access to the PKI functions contained on a user's smartcard, and this requirement means that in most cases a user will remove the smartcard from their person and leave it on or in a smartcard reader while working at the computer. Security policy generally dictates that users must remove their smartcard when leaving their workstation. However, this constant requirement for a smartcard to be available to the terminal or reader encourages the person to leave their smartcard attached to their computer, even when they leave their machine unattended.

Further, contactless smartcard readers tend to be bulky and inconvenient to mobile users, such as those on laptop computing devices.

The present invention advantageously provides an alternative to authentication methods in a contactless environment. The system and method according to certain embodiments of the present invention may advantageously be used to maintain highly secure functionality in a contactless environment.

### SUMMARY OF THE INVENTION

According to a first aspect of the invention, there is provided a method of providing continuous authentication in a contactless environment. The method includes providing a reader having a contactless interface, as well as a device, operable to communicate with the reader. The method further includes the steps of receiving at the reader a first authentication request from the device, and communicating from the reader a second authentication request to a secure transaction service. The secure transaction service holds authentication credentials relating to the device. Authentication credentials relating to the device are received at the reader from the secure transaction service, and the reader provides continuous authentication based at least in part on the authentication credentials received from the secure transaction service.

According to another aspect of the invention, there is provided a system to provide continuous authentication in a contactless environment. The system includes a reader having a contactless interface, a device operable to communicate with the reader, and a secure transaction service. The reader provides continuous authentication based at least in part, on authentication credentials relating to the device provided by the secure transaction service.

In accordance with a further aspect of the invention, there is provided a method of providing continuous access to cryptographic services in a contactless environment. The method includes providing a reader having a contactless interface, as well as a device, operable to communicate with the reader. The method further includes receiving at the reader a first set of authentication credentials from the device. The reader communicates an authentication request to a secure transaction service, where the secure transaction service holds a second set of authentication credentials relating to the device. The reader receives the second set of authentication credentials relating to the device from the secure transaction service, and provides continuous access to cryptographic services based at least in part on the second set of authentication credentials received from the secure transaction service and the first set of authentication credentials received from the device.

According to another aspect of the invention, there is provided a system to provide continuous access to cryptographic services in a contactless environment. The system includes a reader having a contactless interface, a device, operable to communicate with the reader, and a secure transaction service. The reader provides continuous access to cryptographic services based at least in part on a first set of authentication credentials provided by the device, and a second set of authentication credentials relating to the device provided by the secure transaction service.

According to yet another aspect of the invention, there is provided a contactless reader that provides continuous authentication based at least in part on authentication credentials relating to a device provided by a remote secure transaction service.

In one embodiment of the invention, the reader further includes a microprocessor and a secure element operable to communicate with the secure transaction service to receive and process at least part of the authentication credentials. The remaining part of the authentication credentials required for continuous authentication is provided to the reader by the device.

In another embodiment of the invention, the device is a smartcard, portable radio device or smart mobile communication device. In a further embodiment, the reader further includes a field generator circuit to power the device by providing a radio field.

In another embodiment of the invention, the reader includes a USB interface, and further includes a memory drive that is accessible once continuous authentication has been provided. In one embodiment, access to the memory drive is through the USB interface.

In another embodiment of the invention, the secure transaction service is remote from the reader, and is an escrow service.

### BRIEF DESCRIPTION OF THE DRAWINGS

The invention will now be described in a non-limiting manner with respect to a preferred embodiment in which:

FIG. 1 is an overview of a preferred embodiment of the present invention;

FIG. 2 is a further overview of a preferred embodiment of the present invention;

FIG. 2a is a process diagram showing a preferred embodiment of the authentication process according to the present invention;

FIG. 3 is an overview of an alternative arrangement of another preferred embodiment of the present invention.

FIG. 4 is a further process diagram showing a preferred embodiment of the ‘time out’ process according to the present invention; and

FIG. 5 is a process diagram showing a preferred embodiment of the re-authentication process according to the present invention.

FIG. 6 is a concept diagram showing the preferred physical embodiment of the device.

FIG. 7 is an overview of a reader employed in a building security system in accordance with a preferred embodiment of the present invention.

### DETAILED DESCRIPTION OF PREFERRED EMBODIMENTS

In the following discussion and in the claims, the terms “including” and “includes” are used, and are to be read, in an open-ended fashion, and should be interpreted to mean “including, but not limited to . . . ”.

Additionally, in the following discussion and in the claims, the term “device” is to be given a broad meaning and generally refers to an RFID smartcard device that may communicate with a number of systems. The term “device” may also encompass a proximity card. Further, it is to be understood that other RFID devices that contain a contactless microprocessor such as ‘smart’ mobile communication devices, portable radio devices, passports, driver's licences, credit and debit cards (including, but not limited to, EMV authentication standards), MIFARE cards and DESFire devices, governmental or financial institution issued identification cards (such as Personal Identity Verification (PIV) cards) may be substituted/interchanged for/with a smartcard in accordance with preferred embodiments of the present invention.

The term “contactless”, as used in the following discussion and in the claims, is to be given a broad meaning and relates to an environment where a device may communicate with a reader without physical contact between the device and the associated reader. It will be appreciated however, that such an environment may include a very small amount of physical contact, such as a brief touch of the device onto the reader, as is commonly known as a ‘touch and authenticate’ operation. The contactless environment of the present invention relates generally to ISO 14443, ISO 15693 and NFC (Near Field Communication). It will be appreciated by those of skill in the art that other relevant standards could be adopted, as appropriate.

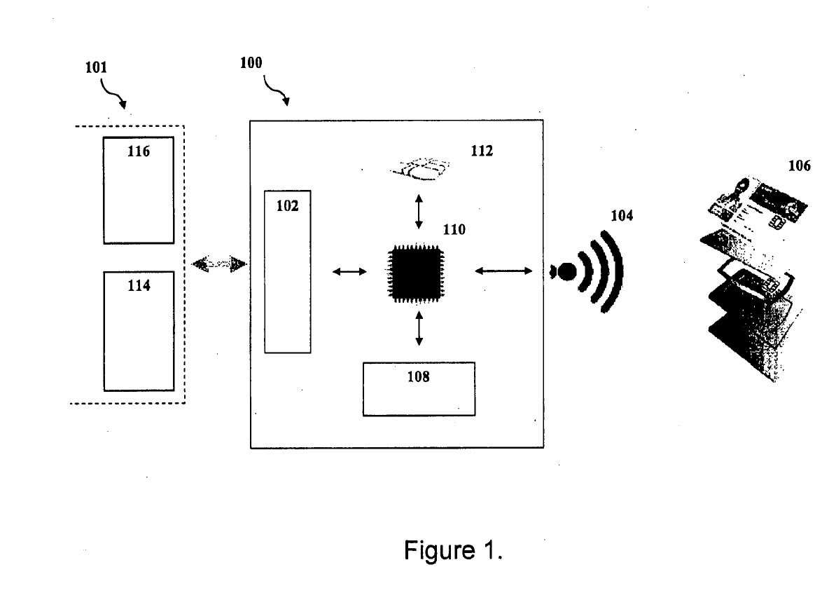

Turning now to FIG. 1, there is shown a preferred embodiment of the present invention. Reader 100 is preferably a RFID contactless reader with a back end Universal Serial Bus (USB) interface 102 for connection or interface with a host computer 101, such as a PC or laptop, mobile phone or other suitable device. The interface may also be a Serial interface or other appropriate interface that will be apparent to one of skill in the art.

The peripheral device interface unit 104 allows the reader 100 to act as a compliant Chip/SmartCard Interface Device (CCID) or other relevant smartcard interface standard reader by interacting with a host computer 101 through the interface 102. The peripheral device interface unit 104 operates in the frequency range of 13.56 MHz, allowing for communication with a device 106, such as a smartcard, RFID tag, smart mobile device or other ISO 14443 compliant device.

It will be appreciated that the interface unit 104 may operate at multiple frequencies to accommodate legacy or alternative technologies, such as proximity cards operating at 125 kHz. This may be achieved by a transmitting antenna (not shown) being tuned to a plurality of frequencies such as 13.56 MHz and 125 kHz or multiple antennas individually tuned to the desired frequency.

The reader 100 preferably also includes a field generator circuit (not shown) to provide power to the RFID device 106 using radio field inductive technology or other short-range communication technology capable of communicating via electromagnetic field induction. It will be appreciated that the reader 100 would deliver power to an antenna (not shown) through the field generator circuit, where a current is induced and transmitted to the RFID device 106. An antenna at the device 106 receives the current and powers its microprocessor. Modulating the established RF field allows the microprocessor of the device 106 and the reader 100 to communicate with each other. The reader 100 may include an internal battery to provide power to the field generator circuit, or alternatively, draw the required power from the host computer 101.

Further, proximity cards are generally passive devices obtaining a power supply from the rectified electromagnetic fields received at the on-board antenna. The received electromagnetic waves act like AC signals that, after rectification, can be regulated to power electronic equipment. In order for the reader of the present invention to operate at multiple frequencies, such as 13.56 MHz and 125 kHz, the power supply provided by the host computer 101 (through a USB port, for example) is preferably applied to a regulator to create an additional DC voltage. The combination of the at least one antenna, rectifier and regulator allows dual-power capabilities for the reader, where capacitive couplings between the rectifier and regulator minimize the impact of the DC voltage received from the host computer 101 on the AC signal present at the antenna.

Preferably, RFID reader 100 also includes a memory drive 108 that may be accessed by the host computer 101 through the interface 102. The memory drive 108 is preferably a solid-state storage device allowing for non-volatile flash memory, and is preferably locked and encrypted using the secure element 112. The memory drive may also be a micro secure digital (SD) memory, or other suitable form of storage. Microprocessor 110 coordinates the interface access for both the memory drive 108 once verified access has been ascertained, and the peripheral device interface unit 104 in accordance with the secure authentication techniques and methods of the present invention.

Secure element 112, is a dedicated cryptographic microprocessor that performs the relevant encryption and authentication functions. The secure element 112 temporarily stores the unique PKI keys and certificates relating to the device, when an authentication request is received from the device 106. The secure element controls security and PKI authentication by assigning and managing security attributes.

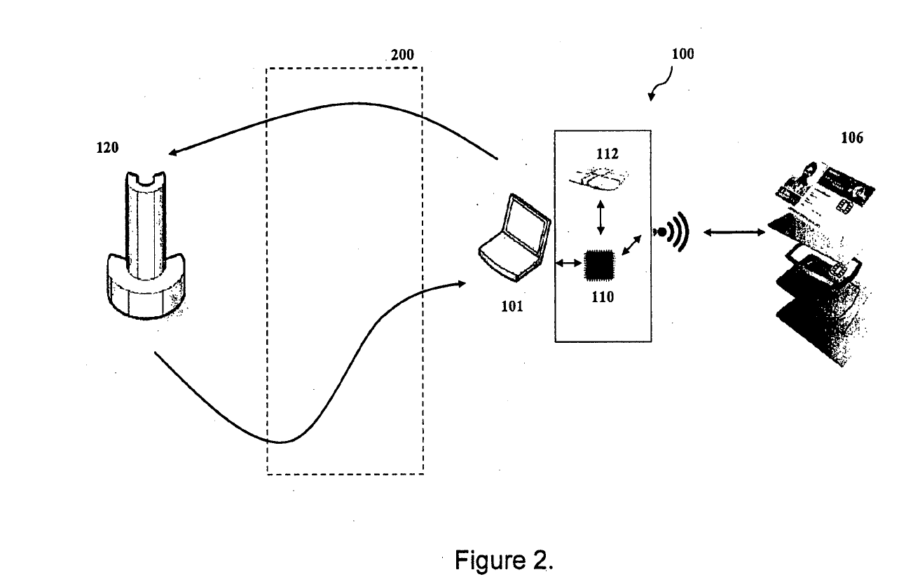

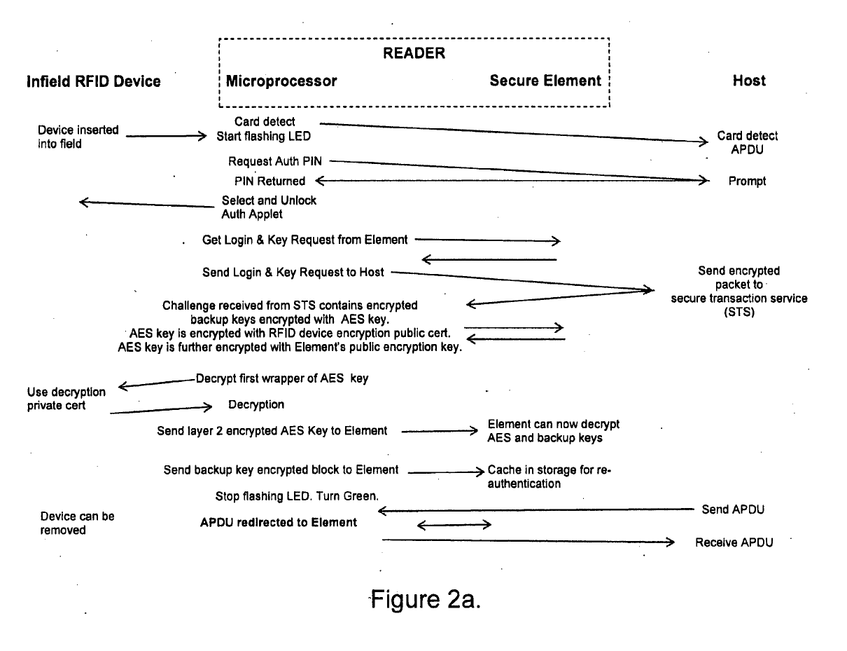

The method of secure continued authentication in a contactless environment will now be described in a non-limiting manner with reference to FIG. 1 and FIG. 2, and the process diagram shown in FIG. 2a.

At first instance, the RFID reader 100 is inserted into a host computer 101 via a suitable interface such as a USB connection. As mentioned above, any suitable interface may be adopted for the reader to communicate with the host computer and may include, but is not limited to, a Serial or even wireless interface.

The reader 100 registers with authentication interface driver 114 through the host computer 101. A first authentication request for a continuous authentication session occurs when a smartcard or other device 106 is detected by the peripheral device interface unit 104. It will be appreciated that an authentication request may simply occur by a user moving their device 106 into the range of the peripheral device interface unit 104, or briefly touching the unit 104 with the device 106. The microprocessor 110 invokes the CCID smartcard driver 116 to request and retrieve identification information from the smartcard user via a suitable interface on the host computer 101, such as a Graphical User Interface (GUI). Identification information may include, but is not limited to, a personal identification number (PIN) or biometric attributes such as a retinal scan or fingerprint. Once the smartcard user is identified, the smartcard or RFID device 106 moves to an ‘unlock’ state.

The microprocessor 110 then activates the secure element 112, and interacts with the device 106 using a PKI certificate and the private key stored on the device 106 to authenticate the user.

The secure element 112 reverts to its internal memory to identify if the authenticated user matches authentication credentials previously received and stored in cache. Authentication credentials preferably include a set of encrypted keys and certificates securely stored for PKI authentication, encryption and signing.

It will be appreciated that if the authentication credentials are located in cache (or on the user device to be transferred to the reader), the reader may authenticate itself with the host as a CCID reader to provide the user with secure IT and online transactions or access to the relevant memory drive. This may occur for example, when the previously authenticated secure session is inactive for a predetermined period of time. Further description of the ‘time out’ and re-authentication processes is outlined below.

If the authentication credentials are not identified in the internal cache of the secure element 112, the secure element 112 sends a second authentication request through the microprocessor 110 to a secure transaction service 120 using the received device's authentication credentials and appropriate smartcard authentication request commands, such as application protocol data units (APDU). The second authentication request transaction may be sent and received over any appropriate secure medium 200, such as the internet.

The secure transaction service 120 is preferably a remote secure escrow database that stores copies of registered RFID devices' PKI public authentication keys and certificates for registered users. The secure transaction service 120 is preferably independent from any specific PKI application and acts as a secure mechanism for distributing relevant PKI certificates relating to a user and their device. It will be appreciated that the secure escrow service 120 may store backup copies of relevant authentication credentials and/or secondary PKI certificates.

Once the second authentication request is received, the secure transaction service 120 must validate and authenticate the secure element 112 of the reader 100. This may be achieved in a number of ways. For example, and as illustrated in FIGS. 2 and 2a, the secure transaction service 120 may issue a challenge back to the secure element 112 via the microprocessor 110 over the secure medium 200. The challenge is then processed by the secure element 112 and a response forwarded to the secure transaction service 120. Upon validation, the secure transaction service 120 securely sends the relevant user's secondary PKI certificates to the secure element 112 within the reader 100. The secure element 112 then makes the received secondary PKI certificates available to the host computer 101 through the microprocessor 110, simulating the device. The reader 100 has now taken over the responsibility of providing the user's valid secondary PKI certificates to the host 101.

Device 106 may then be removed from the reader's field. Continuous authentication and appropriate APDU functionality in the contactless environment may be managed by the secure element 112 through the microprocessor 110 of the reader 100 based at least in part on the authentication credentials (such as the secondary PKI certificates) received from the secure transaction service 120. It is this secure distribution of the relevant PKI certificates to the secure element 112 within the reader 100 that allows the user to remove their device containing primary certificates from the reader's radio frequency field, and yet maintain continuous authentication in the contactless environment. That is, as the PKI certificates and keys are now stored in the secure element 112, the host computer 101 will interpret a valid smart card in a CCID reader, and can send the full set of supported APDUs.

Access to the secure memory drive 108 of the reader 100 may also be managed by the microprocessor 110 using at least part of the authentication credentials and cryptographic keys managed by the secure element 112.

It will be appreciated that secure information stored on the memory drive 108 of the reader 100 may only be accessed as a virtual drive by authorised users. Once the secure element 112 authenticates the external contactless device 106 using at least part of the authentication credentials received from the secure transaction service 120 and stored in the secure element 112, the secure element 112 works with the microprocessor 110 to inform the host computer 101 that a removable USB memory drive is available and its contents are decrypted as required. Therefore, the present invention advantageously secures the viability of important information/data carried away from secure servers, such as on a memory drive. If a previously authorised user's status becomes invalid (for example, if the user leaves the employment of the smartcard issuer), the data on the drive is inaccessible to the user, despite the drive being in the user's possession.

To facilitate environments where multiple users may use the one host computer 101, such as an internet kiosk or a communal terminal, the encrypted flash memory 108 of the reader may be used as a secure cache of authentication credentials for PKI authentication. The cache preferably allows the configuration of a ‘time out’ that would ensure that any unused cache data is removed in a timely and secure manner. In accordance with the method of authentication of the present invention, when a user presents their RFID device 106 to the reader 100, the secure element 112 authenticates them and retrieves their PKI credentials from the encrypted cache. The relevant certificates are then activated within the secure element 112 and the host computer 101 is informed that an authorised device has been presented. The device may then be removed from the reader's field, while continuous access to cryptographic services, such as authentication, encryption, and signing, is maintained in the contactless environment.

It will also be appreciated that the microprocessor 110 can control access to functionality provided by the host computer, using the authentication credentials supplied by the secure element 112. For example, the host computer may be a remote PC terminal, such as a laptop computer. Access to files stored on the host computer or access to the functionality of secure transactions may only be provided to authorised users in possession of a valid device, such as a smartcard or ‘smart’ mobile communication device.

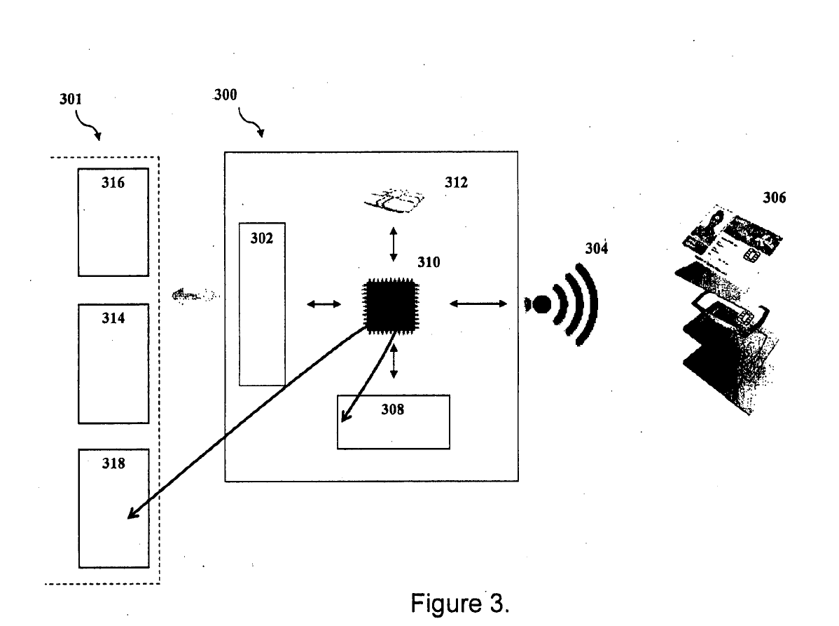

Further, and as shown in FIG. 3, access to a host memory drive 318 can be controlled by the reader 300 using the methodology of the present invention, incorporating the microprocessor 310 and the secure element 312. The host memory drive 318 is preferably a removable flash drive, such as a USB thumb drive. However, the host memory drive 318 may be permanently attached to the host computer 301, whether it be an external hard drive permanently attached as a peripheral device, or internal storage of the host computer 301.

In accordance with a preferred embodiment of the invention shown in FIG. 3, a first authentication request for a continuous authentication session occurs when a smartcard or other device 306 is detected by the peripheral device interface unit 304. Once the user is authenticated using the methodology of the present invention described above, the secure element 312 enters an unlocked state so that the microprocessor 310 can perform the required cryptographic operations or access the encryption keys. The microprocessor 310 informs the host computer 301 that the memory drive 318 is available, and decrypts the relevant encrypted portions of the memory drive 318 incorporating the secure element 312, as required. The user may remove their device 306 from the field of the reader 300, yet still have continuous authentication in the contactless environment for the required period.

It will be appreciated that relevant authentication credentials may be encrypted on the memory drive 308 of the reader. Access to the memory drive 308 may only be granted upon a request from the secure element 312 through the microprocessor 310, as appropriate. For example, the presentation of the authenticated device allows the reader 300 to unlock the secure element 312 and decrypt the internal memory 308, to provide authenticated access to the host memory drive 318.

In an alternative embodiment of the present invention, the reader can accept proximity cards operating at 125 kHz. Once the reader detects the use of such a card, it energises the proximity card to receive its identification information as a first authentication request, which would generally include a clear text 26-40bit serial number. The reader of the present invention would incorporate the identification information with the authentication credentials supplied by the secure element 112. To further confirm and identify the user of the proximity card, the reader may also prompt the user for a further form of identification, such as a PIN or biometric information. In this embodiment, the reader acts as a translator, providing access to digital resources with full PKI.

In order to create a suitable magnetic coupling between a low-frequency reader and a card device operating at 125 kHz, an antenna with 1 mH-10 mH inductance and a quality factor higher than 30 is preferably required. As will be appreciated, the design of an antenna operating at 125 kHz requires numerous copper wire turns/windings to create the desired inductance. However, the windings occupy a relatively large area on a printed circuit board.

The antenna size may be reduced by placing a ferrite core in its centre. A ferrite core enables a low impedance path for electromagnetic waves. Additionally, the ferrite core increases the field density and thereby increases the inductance. Despite these advantages, placing a ferrite core inside an antenna designed over a printed circuit board can be costly.

In a particularly preferred embodiment of the present invention allowing functionality of the system to operate at 125 kHz, a plurality of inductors with ferrite cores are placed at the edge of the printed circuit board of the reader's antenna. The inductors are connected using copper wire enabling a large inductance from only a single-turn antenna structure. The field power provided by this distributed inductive coupler antenna configuration can vary from 1 mW to 10 mW and is reliant on the field power available as well as the area of the single turn antenna structure, which can vary from the size of a small USB device (1 cm by 1 cm) to a flexible proxy card (3 cm by 4 cm).

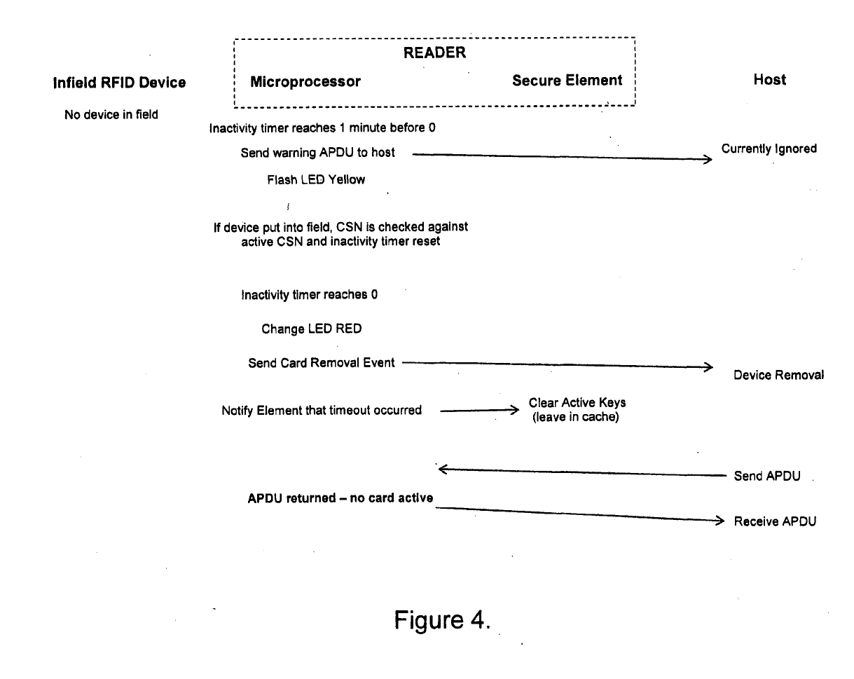

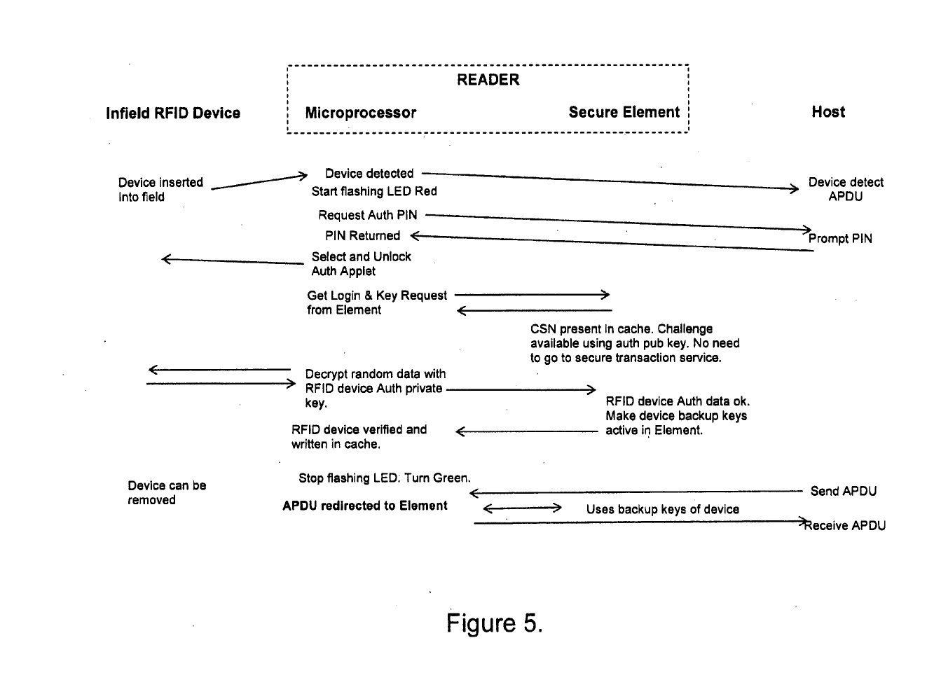

The following description, with reference to FIGS. 4 and 5, outlines a preferred process during a ‘time out’ phase, as well as the re-authentication process that may occur after a time out phase is detected.

FIG. 4 shows a process diagram in accordance with a preferred embodiment of the present invention, where the authenticated session remains inactive for a predetermined period of time.

An inactivity timer built in to the microprocessor counts down a predetermined period of time, and initiates a warning to the host computer when the period is about to expire. The example shown in FIG. 4 is one minute from the expiration of the time period. Should no activity occur before the expiration of the predetermined period of time, the microprocessor will initiate a device removal event, where the host computer and secure element are notified of the end of an authenticated session. The secure element will clear the active certificates and key, thus returning the secure element to the locked state, but will leave the authentication credentials in cache for re-authentication as required.

FIG. 5 outlines the preferred process for re-authentication in accordance with the present invention. The initial process of a first authentication request (that is, placing the RFID within the field of the reader to gain validated access to secure data and/or functionality) is generally the same as that described above. However, in most cases, re-authentication will not require the microprocessor to initiate contact with the secure transaction service (such as the second authentication request described above), as the relevant authentication credentials (such as the second set of authentication credentials) can be identified in the cache of the secure element. The above described challenge-response process may then occur without the interaction of the secure transaction service.

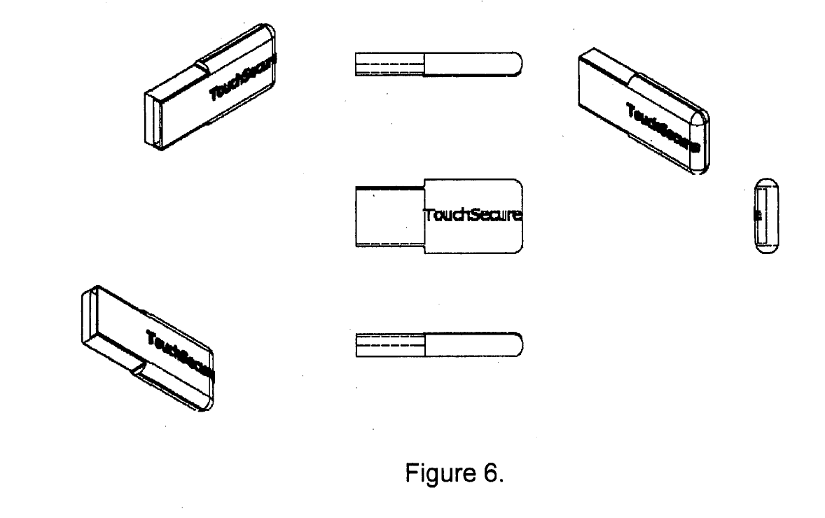

FIG. 6 shows a preferred physical embodiment of the reader. The interface to a host computer is shown as a USB interface. However, it is to be appreciated that the interface may be suitable for any form of secure communication, and may include, but is not limited to, Serial communication or wireless communication. In a particularly preferred embodiment, the reader includes a high efficiency antenna (not shown) that allows the design of the reader to remain small and convenient to laptop computers. The size of the unit advantageously overcomes the bulky problems associated with prior art contactless readers.

Table 1 shows an example of technical specifications of the reader in accordance with a particularly preferred embodiment of the present invention.

TABLE 1
An Example of Technical Specifications in Accordance with a
Particularly Preferred Embodiment of the Present Invention

| Feature | Specification |
|---|---|
| Interfaces | Full speed USB 2.0 (12 Mbps) |
| Power | USB Bus host powered device |
| Smart Card Driver Compatible | CCID v1.1 compliant |
| Smartcard Interface Protocols | T = 0, T = 1 protocol support |
| Communication Speed | up to 344,105 bps |
| Operating Systems | Windows ® 7 |
| | Windows ® Vista, XP, Server 2003 |
| | MacOS, Solaris, Linux 32-bit (2.4.x, |
| | 2.6.x)/64-bit |
| Cable | USB direct connect |
| Human Interface | Tri-color LED indicates status, activity |
| | and error conditions. |
| Approvals | FCC Class B part 15, CE |
| API | PC/SC compatible, CCID v1.1 |
| L × W × H [mm] | 24 × 18 × 5 |
| Temperature [° C.] | 0 to 50 |
| Environmental | RoHS |
| Memory Card Support | optional microSD |
| Memory Card Encryption | 128 bit AES |
| Internal Secure Element | 64k JavaCard SmartMX |
| Operating Frequency | 13.56 Mhz (and 125 kHz) |
| Radio Standard | 14443a/b (ISO 15693) |
| Memory Card Encryption | PIV, EMV contactless, MIFARE, |
| Contactless Authentication | DESFire, iClass, MRTD ePassport |
| Support | |

The present invention has particular advantages in a shared terminal environment. For example, in a health care facility environment, such as a hospital, shared terminals may be viewed by many users with varying levels of authorised access to relevant data. This presents a significant issue for security of information. The present invention allows for high speed authentication of a user by placing their relevant device (such as their identity card) in the field of the reader. The reader enables a full set of PKI authentication, encryption and data signing transactions without the need for the user's device to remain in the vicinity or in contact with the reader. The time-out phase outlined above will ensure the host/shared computer is locked after a predetermined period of time should no activity be detected. It will be appreciated that the present invention may leverage and comply with industry standards, such as FIPS 201, PC/SC and CCID v1.1, allowing the reader to be compatible with existing smartcard authentication framework that may be included with, for example, CCOW context managers.

The above description has outlined a secure transaction service acting as a PKI escrow service holding relevant authentication, encryption and signing certificates and private keys. However, the system in accordance with a preferred embodiment of the present invention, allows non-subscribed devices (that is, user authentication credentials that have not registered with the secure transaction service) to receive continuous authentication in a contactless environment. This may be achieved by pre-loading the authentication credentials, such as PKI credentials, into the reader and securely storing them in the internal memory drive. The user can then authenticate themselves to the reader by using a suitable device, resulting in true PKI authentication techniques in accordance with the present invention.

Further, pre-loaded PKI credentials supplied to the memory of the reader allow presentation of a non-PKI based device to achieve authentication in a contactless environment. Once the non-PKI device is authenticated (using biometric attributes, for example), the reader can emulate a PKI device.

For example, if a user misplaces their contactless identification card, the user may authenticate themselves using an alternative form of identification, such as an e-passport or e-driver's license. In this embodiment of the present invention, the reader would communicate a second authentication request to the secure transaction service after receiving and processing a first authentication request from the user's alternative device. The secure transaction service may then match the relevant credentials received from the reader, and if the device source is trusted in accordance with security provisions, the reader can provide continuous authentication for the device based at least in part on authentication credentials received from the secure transaction service.

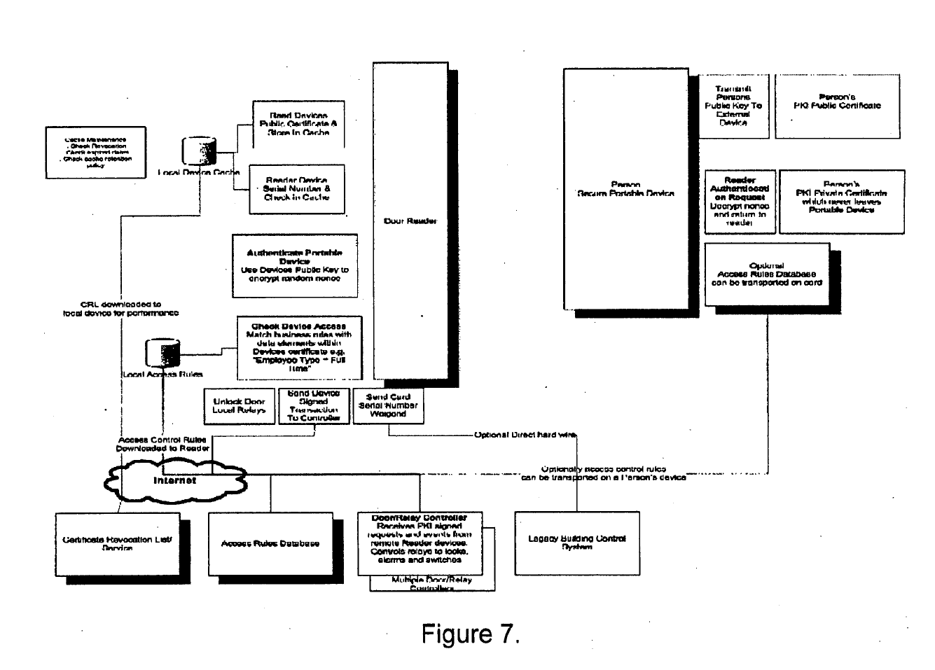

The present invention may be implemented in a range of environments where authentication of a user using PKI is required. An alternative embodiment of the present invention involves a door reader in a building security system; a configuration of which is shown in FIG. 7.

Whilst PKI transactions provide a high level of security, traditional physical access systems such as electronic locking mechanisms are unable to implement true PKI due to speed. However, storing certificates in the respective door reader's cache in similar regard to that described above, removes the need for certificates from the smartcard device to be re-read, saving time in the authentication process. It will be appreciated that additional levels of security, such as a PIN pad or biometric reader, may be implemented in conjunction with the PKI transaction to allow access to a particular region of a secure location.

Further, business access rules may be configured in the reader that limit physical access to a particular region to additional limitations such as time of day, and security clearance.

It is to be understood that the above embodiments have been provided only by way of exemplification of this invention, and that further modifications and improvements thereto, as would be apparent to persons skilled in the relevant art, are deemed to fall within the broad scope and ambit of the current invention described and claimed herein.

1. A method of providing continuous authentication in a contactless environment, including:
providing a reader having a contactless interface;
providing a device operable to communicate with the reader;
receiving at the reader a first authentication request from the device;
communicating from the reader a second authentication request to a secure transaction service, the secure transaction service holding authentication credentials relating to the device;
receiving at the reader authentication credentials relating to the device from the secure transaction service;
wherein the reader provides continuous authentication based at least in part on the authentication credentials received from the secure transaction service.

2. The method according to claim 1, wherein the authentication credentials are communicated from the secure transaction service to a microprocessor and a secure element of the reader where at least part of the authentication credentials are processed; and
wherein the remaining part of the authentication credentials required for continuous authentication is provided to the reader by the device.

3. The method according to claim 1, wherein the device is a smartcard, portable radio device or smart mobile communication device.

4. The method according to claim 1, wherein the reader provides a radio field to power the device.

5. The method according to claim 1, wherein the reader includes a USB interface.

6. The method according to claim 1, wherein the reader includes a memory drive that is accessible once continuous authentication has been provided.

7. The method according to claim 6, wherein access to the memory drive is through the USB interface.

8. The method according to claim 1, wherein the secure transaction service is remote from the reader.

9. A system to provide continuous authentication in a contactless environment, including:
a reader having a contactless interface;
a device, operable to communicate with the reader; and
a secure transaction service;
wherein the reader provides continuous authentication based at least in part on authentication credentials relating to the device provided by the secure transaction service.

10. The system according to claim 9, wherein the reader further includes a microprocessor and a secure element operable to communicate with the secure transaction service to receive and process at least part of the authentication credentials; and
wherein the remaining part of the authentication credentials required for continuous authentication are provided to the reader by the device.

11. The system according to claim 9, wherein the device is a smartcard, portable radio device or smart mobile communication device.

12. The system according to claim 9, wherein the reader further includes a field generator circuit that provides a radio field to power the device.

13. The system according to claim 9, wherein the reader includes a USB interface.

14. The system according to claim 9, wherein the reader includes a memory drive that is accessible once continuous authentication has been provided.

15. The system according to claim 14, wherein access to the memory drive is through the USB interface.

16. The system according to claim 9, wherein the secure transaction service is remote from the reader.

17. A method of providing continuous access to cryptographic services in a contactless environment, including:
providing a reader having a contactless interface;
providing a device, operable to communicate with the reader;
receiving at the reader a first set of authentication credentials from the device;
communicating from the reader an authentication request to a secure transaction service, the secure transaction service holding a second set of authentication credentials relating to the device;
receiving at the reader the second set of authentication credentials relating to the device from the secure transaction service;
wherein the reader provides continuous access to cryptographic services based at least in part on the second set of authentication credentials received from the secure transaction service and the first set of authentication credentials received from the device.

18. The method according to claim 17, wherein the second set of authentication credentials are communicated from the secure transaction service to a microprocessor and a secure element of the reader where at least part of the second set of authentication credentials are processed.

19. The method according to claim 17, wherein the device is a smartcard, portable radio device or smart mobile communication device.

20. The method according to claim 17, wherein the reader provides a radio field to power the device.

21. The method according to claim 17, wherein the reader includes a USB interface.

22. The method according to claim 17, wherein the reader includes a memory drive that is accessible once continuous access to cryptographic services has been provided.

23. The method according to claim 22, wherein access to the memory drive is through the USB interface.

24. The method according to claim 17, wherein the secure transaction service is remote from the reader.

25. A system to provide continuous access to cryptographic services in a contactless environment, including:
a reader having a contactless interface;
a device, operable to communicate with the reader; and
a secure transaction service;
wherein the reader provides continuous access to cryptographic services based at least in part on a first set of authentication credentials provided by the device, and a second set of authentication credentials relating to the device provided by the secure transaction service.

26. The system according to claim 25, wherein the reader further includes a microprocessor and a secure element operable to communicate with the secure transaction service to receive and process at least part of the second set of authentication credentials.

27. The system according to claim 25, wherein the device is a smartcard, portable radio device or smart mobile communication device.

28. The system according to claim 25, wherein the reader further includes a field generator circuit that provides a radio field to power the device.

29. The system according to claim 25, wherein the reader includes a USB interface.

30. The system according to claim 25, wherein the reader includes a memory drive that is accessible once continuous access to cryptographic services has been provided.

31. The system according to claim 30, wherein access to the memory drive is through the USB interface.

32. The system according to claim 25, wherein the secure transaction service is remote from the reader.

33. (canceled)
